(19) United States
(12) Patent Application Publication
(10) Pub. No.: US 2011/0297885 A1
(43) Pub. Date: Dec. 8, 2011

(54) PROCESS TO CONVERT BIOMASS

(76) Inventors: Harold Boerrigter, Amsterdam (NL); Christiaan Nijst, Amsterdam (NL); Sander Van Paasen, Amsterdam (NL); Robertus Hendrikus Venderbosch, Enschede (NL)

(21) Appl. No.: 13/147,390

(22) PCT Filed: Feb. 4, 2010
(86) PCT No.: PCT/EP10/51343

§ 371 Date: Aug. 29, 2011

(30) Foreign Application Priority Data
Feb. 4, 2009 (EP) 09152033.8

(51) Int. Cl. C01B 3/36; C10L 5/36; C10L 5/44

(52) U.S. Cl. 252/373; 44/589; 44/530

(57) ABSTRACT

The invention is directed to a process to prepare a fuel or an intermediate to a fuel from residues as obtained in a palm oil process wherein shredded agricultural residue having a water content of between 40 and 75 wt % water is dried to obtain a dried agricultural residue having a water content of between 5 and 40 wt % and then is compacted into pellets, cubes, or small briquettes having a two dimensional size of between 5 and 1000 mm and a thickness of between 5 and 300 mm and a density of between 200 and 1200 kg/m³.

The present invention relates to a process to convert biomass, such as empty fruit bunches as obtained from the palm oil production process, oil palm fronds and oil palm trunks, as well as mixtures of two or more of the foregoing to a fuel or an intermediate for a fuel. Also, other agricultural residues, such as straw, may also be used.

In the palm oil production chain large quantities of biomass by-products (up to almost 5× the oil production) are generated which have a limited use in adding value to the production chain. The current palm oil production system has sustainability challenges. Furthermore, current production and processing methods are associated with pollution and greenhouse gas emissions. The use of by-products for energy and green chemicals offers perspectives for improving the environmental impact of a food oil production chain that fits well in the development of a biobased economy. The major topics for discussion of sustainable palm oil production so far, have concentrated on the issues of rain forest loss, soil fertility and reproduction, biodiversity, pest and water management and the emission of greenhouse gasses. Utilising the available energy that can be derived from biomass by-products has been recognised and in many cases residues from oil production are used to provide the energy required to run the plant operation. Utilising these materials for energy purposes can decrease the associated production of greenhouse gases, methane and CO₂ from degradation of residues on the fields.

The main by-products generated in the palm oil production are the plantation field by-products, such as oil palm fronds (OPF), roots and trunks and the by-products obtained at the palm oil mill, such as for example empty fruit bunches (EFB), fruit fibers, kernel shells, palm oil mill effluent and palm kernel cake. It is estimated that in, for example, Malaysia the potential amount of biomass is to be between 30 to 50 million tons at the mill and 70 to 80 million tons in the field. Most of this material is found in Malaysia, which accounts for almost 50% of world palm oil production and in Indonesia, which accounts for almost ⅓ of world palm oil production.

Currently only part of the total by-products is utilised, in many cases as mulch, pulp or fibre. The bulk of the EFB is not utilised for fertilisation or mulching; trunks have no significant application other than as mulch, and not all OPF are required for plantation soil quality control.

The present invention now provides the following process to convert the by-products obtained from the palm oil production process and other agricultural residues, such as straw, to a fuel or an intermediate for a fuel.

The present invention is a process to prepare a fuel or an intermediate to a fuel from a residue as obtained in a palm oil process wherein shredded empty palm oil fruit bunches (EFB), OPF and OPT, as well as other agricultural residues having a water content of between 40 and 75 wt % water, having an average diameter of between 10 mm and 100 mm are dried at ambient conditions or conditions slightly above ambient to obtain a dried biomass material having a water content of between 5 and 40 wt %.

Applicants found that by drying at ambient or temperature conditions slightly above ambient conditions an economic attractive process is obtained to dry shredded empty palm oil fruit bunches and other agricultural residues.

Drying at ambient conditions has the meaning according to the present invention in that the natural environment supplies the required heat for evaporation, especially by the radiation heat of the sun. Preferably the shredded agricultural residues are present during the drying step under a light permeable roof and are periodically mechanically turned. The shredded agricultural residues are suitably spread out on a surface facing the sun. The height of the bed is suitably between 5 and 30 cm and more preferably around 10 cm. In case a roof is used, means to refresh the air above the bed of shredded agricultural residues are preferably present. Such means is suitably a fan. The bed of shredded agricultural residues is preferably periodically turned such that the drying is optimised. This turning is preferably performed by means of a mechanical shovel. An example of such means is suitably a rotating cylinder provided with shovels. The cylinder is located at a distance above the bed and when the cylinder rotates the shovels will mix the bed. Preferably the cylinder can move relative to the bed via a rail such that one cylinder can mix a larger, preferably rectangular, area. The residence time in the drying step is between 20 and 150 hours. An example of a suitable drying process is described in Shingo Furuichi, Mat Daham Mohd. Duad, Junichi SATO; Nogyo Kikai Gakkai Nenji Taikai Koen Yoshi (2003), Development of Solar Drying Technology for Processing of Oil Palm Fronds into Animal Feed-Drying Characteristic of OPF in Solar Drying Greenhouse,—VOL. 62nd; PAGE 411-412 (2003). Preferably the shredded EFB have been de-oiled to obtain a de-oiled shredded EFB with an oil content of below 2 wt %.

Drying at conditions slightly above ambient has the meaning according to the present invention in that the natural environment supplies the air for evaporation and the air is heated to a maximum of 60 degrees C. with an external source, preferably waste heat from the palm oil mill. Drying with air heated above 60 degrees C. is less advantageous as then expensive materials need to be used in the dryer. Drying is preferably performed in a belt dryer in which ambient air at a temperature between ambient and 60 degrees C. is contacted cross current with the biomass, meaning that, as the dryer belts and biomass layers are porous, the (heated) air preferably passes from bottom to top through the dryer belts and the biomass layers thereon; however, other modes of contacting the (heated) air with the biomass may be used. Such belt dryers are commercially available from a number of suppliers, such as Jansen Poultry Equipment, Harselaarsweg 32, 3771 MB Barneveld, The Netherlands. The residence time in the drying step is between 3 and 60 hours. A further advantage of the belt dryer over the solar bay drying with mechanical agitation is that in the latter dust is generated resulting in dust issues and loss of biomass.

The dried EFB, OPF, OPT or other biomass material as obtained by the process according the present invention is preferably compacted in pellet, cubes or small briquette form, the size depending on the downstream further application, but typically having a two-dimensional size between 5 and 1000 mm and thickness between 5 and 300 mm and a density of between 200 and 1200 kg/m³. Cubes are preferred. The biomass may be compacted into pellets, cubes or small briquettes using commercially available machinery. Cubers useful in the present invention include those such as from Warren & Baerg Manufacturing, Inc., 39950 Road 108, Dinuba, Calif., USA. Pelletizers useful in the present invention include those available from Amandus Kahl, Germany. The dried EFB material is preferably compacted together with shredded and dried oil palm fronds and/or shredded and dried palm oil trunks having a smallest diameter between 10 and 50 mm and a water content of less than 40 wt %.

The shredded palm oil trunks used for the above combined pelletation are preferably obtained by starting from a shredded palm oil trunks having a water content of between 40 and 75 wt % water and having an average diameter of between 10 mm and 100 mm. This material is suitably dried at ambient conditions to obtain a dried material having a water content of between 5 and 40 wt %. The drying at ambient conditions is preferably as described above for the shredded EFB.

The invention is also directed to a drying process of shredded palm oil trunks as described above. Suitably the drying at ambient conditions of the shredded palm oil trunks can be performed in admixture with shredded oil palm fronds.

If oil palm fronds (OPF) are used in any of the above processes it is preferred to use fronds which are pre-dried on the oil plantation field. This is advantageous because the average water content can be substantially reduced, for example from 75 wt % to 20 wt % water. A further advantage is that the majority of the potassium and chlorides as present in the fresh fronds are leached out by means of rain water. This will result in that less additional fertiliser has to be used. A next advantage is that the fronds protect the soil of the plantation field against erosion and increase the water retention of said soil.

The compacted pellets, cubes or small briquettes (further collectively referred to as lumps) as obtained by the above processes can be used as a fuel for power generation or alternatively further processes as will be described below. In one embodiment they are subjected to a torrefaction process. Preferably, prior to performing the torrefaction step, the EFB, or any feed mix comprising the lumps is dried to a water content of between 10 and 25 wt %. Torrefaction is a thermal treatment of the compacted lumps as performed at relatively longer residence time in the absence of added molecular oxygen. Preferably the compacted lumps are heated to a temperature of between 210 and 350° C. for a period of between 10 and 120 minutes to obtain a solid torrefied fuel.

Torrefaction of biomass source material is well known and for example described in M. Pach, R. Zanzi and E. Björnbom, “Torrefied Biomass a Substitute for Wood and Charcoal”, 6th Asia-Pacific International Symposium on Combustion and Energy Utilization, May 2002, Kuala Lumpur and in Bergman, P.C.A., “Torrefaction in combination with pelletisation—the TOP process”, ECN Report, ECN-C-05-073, Petten, 2005.

The torrefied fuel as obtained may be used as fuel for power generation or even more suitably as feedstock to an entrained flow gasification process to prepare a mixture of hydrogen and carbon monoxide. The mixture of hydrogen and carbon monoxide can in turn be used to make all kinds of products, like pure hydrogen, methanol, dimethyl ether, or paraffin based fuels via the Fischer-Tropsch synthesis.

In a second embodiment the lumps are converted into a liquid by means of flash pyrolysis. In flash pyrolysis processes a solid char and a liquid biomass feed component is typically obtained. Preferably the product of the flash pyrolysis is either the liquid or a mixture of the char and the liquid biomass, the pyrolysis slurry. Preferably prior to performing the flash pyrolysis step, the EFB, or any feed mix comprising the compacted lumps is dried to a water content of between 10 and 25 wt %, to obtain compacted lumps having a water content of between 5 and 15 wt %. The, optionally dried, lumps are heated to a temperature of between 400 and 550° C. for a period of between 1 and 30 seconds under an inert atmosphere to obtain a liquid pyrolysis oil or a pyrolysis slurry.

Flash pyrolysis is well known and for example described in EP-A-904335; in Dinesh Mohan, Charles U.

Pittman, Jr., and Philip H. Steele, “Pyrolysis of Wood/Biomass for Bio-oil: A Critical Review”, Energy & Fuels 2006, 20, 848-889; and in E. Henrich, “Clean syngas from biomass by pressurised entrained flow gasification of slurries from fast pyrolysis” in Synbios, the Syngas Route to Automotive Biofuels, conference held from 18-20 May 2005, Stockholm, Sweden (2005).

The pyrolysis oil or pyrolysis slurry as obtained may be used as fuel for power generation or even more suitably as feedstock to an entrained flow gasification process to prepare a mixture of hydrogen and carbon monoxide. The mixture of carbon monoxide and hydrogen can in turn be used to make all kinds of products, like pure hydrogen, methanol, dimethyl ether, or paraffin based fuels via the Fischer-Tropsch synthesis.

1. A process to prepare a fuel or an intermediate to a fuel from biomass as obtained in a palm oil process wherein shredded agricultural residue having a water content of between 40 and 75 wt % water is dried to obtain a dried biomass material having a water content of between 5 and 40 wt % and then is compacted into pellets, cubes, or small briquettes having a two dimensional size of between 5 and 1000 mm and a thickness of between 5 and 300 mm and a density of between 200 and 1200 kg/m³.

2. A process according to claim 1, wherein the drying step is performed under ambient conditions.

3. A process according to claim 1, wherein the drying step is performed in a belt dryer with ambient air.

4. A process according to claim 1, wherein the drying step is performed in a belt dryer with air pre-heated to a maximum of 60 degrees C.

5. A process according to claim 2, wherein the residence time in the drying step is between 20 and 150 hours.

6. A process according to claim 1, wherein the shredded biomass is dried under a light permeable roof and are periodically mechanically turned.

7. A process according to claim 1, wherein the dried biomass is compacted together with shredded oil palm fronds and/or shredded palm oil trunks having a smallest diameter between 10 and 50 mm and a water content of less than 40 wt %.

8. A process according to claim 1, wherein the pellets, cubes, or small briquettes are heated to a temperature of between 210 and 350° C. for a period of between 10 and 120 minutes to obtain a solid torrefied fuel.

9. A process according to claim 1, wherein the pellets or small briquettes are heated to a temperature of between 400 and 550° C. for a period of between 1 and 30 seconds under an inert atmosphere to obtain a liquid pyrolysis oil or a pyrolysis slurry.

10. An entrained flow gasification process to prepare a mixture of hydrogen and carbon monoxide wherein the torrefied fuel obtained by the process of claim 8 is used as feedstock.

11. An entrained flow gasification process to prepare a mixture of hydrogen and carbon monoxide wherein the pyrolysis oil or pyrolysis slurry obtained by the process of claim 9 is used as feedstock.

12. (canceled)

13. A process according to claim 1, wherein the agricultural residue comprises shredded palm oil trunks.

14. A process according to claim 1, wherein the agricultural residue comprises shredded oil palm fronds.

15. A process according to claim 1, wherein the agricultural residue comprises straw.

16. A process according to claim 1, wherein the agricultural residue comprises empty fruit bunches that have been de-oiled to obtain a de-oiled shredded biomass with an oil content of below 2 wt %.

17. A process according to claim 1, wherein the shredded agricultural residue has an average diameter of between 10 mm and 100 mm.
